(19) United States
(12) Patent Application Publication
(10) Pub. No.: US 2019/0219750 A1
(43) Pub. Date: Jul. 18, 2019

(54) LIGHT FILTER AND SENSOR

(71) Applicants: Cambridge Display Technology Limited, Godmanchester (GB); Sumitomo Chemical Company Limited, Tokyo (JP)

(72) Inventors: Jeremy Burroughes, Godmanchester (GB); Andrew Lee, Godmanchester (GB); Jonathan Behrendt, Godmanchester (GB)

(73) Assignees: Cambridge Display Technology Limited, Godmanchester (GB); Sumitomo Chemical Company Limited, Tokyo (JP)

(21) Appl. No.: 16/324,362

(22) PCT Filed: Jul. 28, 2017
(86) PCT No.: PCT/EP2017/069161

§ 371 Date: Feb. 8, 2019

(30) Foreign Application Priority Data
Aug. 10, 2016 (GB) 201613750.7

(51) Int. Cl. G02B 5/22; G01N 21/64

(52) U.S. Cl. CPC G02B 5/223; G01N 2021/6471; G01N 21/645

(57) ABSTRACT

A sensor comprising a light source (103); a photodetector (105); a sample receptacle such as a microfluidic device (101) between the light source and the photodetector; and one or both of a first light filter (107) and a second light filter (109) wherein the first light filter is provided between the sample receptacle and the photodetector and the second light filter is provided between the sample receptacle and the light source. The first light filter may comprise tartrazine. The second light filter may comprise Coomassie violet R200, Victoria Blue B or acid fuchsin. In use, light hν1 emitted from the light source is absorbed by a luminescent indicator in the sample receptacle which then emits light hν2 detected by the photodetector.

### FIELD OF THE INVENTION

The present invention relates to light filters and the use thereof in sensors comprising a light emitter and a photodetector.

### BACKGROUND

Sensors that operate by irradiating a sample and detecting photoluminescence of a luminescent marker in the sample are known, for example as disclosed in Williams et al, Electronics 2014, 3, 43-75 “Integration of Organic Light Emitting Diodes and Organic Photodetectors for Lab-on-a-Chip Bio-Detection Systems”.

However, accuracy of detection of such sensors may be affected by detection of light emitted from the light source.

Lefevre et al, Lab Chip, 2012, 12, 787-793 “Algal fluorescence sensor integrated into a microfluidic chip for water pollutant detection” discloses an organic light emitting diode (OLED) and an organic photodetector (OPD) integrated into a microfluidic chip for detection of algal fluorescence in a microfluidic chamber of the chip. An emission filter is provided between the microfluidic chip and the OLED and an excitation filter is provided between the microfluidic chip and the OPD.

Ryu et al, Lab Chip, 2011, 11, 1664-1670 “Highly sensitive fluorescence detection system for microfluidic lab-on-a-chip” discloses a fluorescence detection system having a InGaN (501 nm) light emitting diode light source, an organic or silicon photodiode detector, absorptive dye coated colour filters and linear and reflective polarisers.

Although filters for use in detection systems are known, there remains a need for filters suitable for use with luminescent indicators that emit green light.

It is an object of the invention to provide a long pass filter suitable for use with green light emitting indicators.

It is a further object of the invention to provide a short pass filter suitable for use with green light emitting indicators.

It is a yet further object of the invention to provide low cost filters for use in sensors comprising a light emitter and a light detector for detection of luminescence from a luminescent marker.

### SUMMARY OF THE INVENTION

The present inventors have found that tartrazine may be provided in a film and used to filter light in a high pass filter.

Accordingly, in a first aspect the invention provides a sensor comprising a light source for irradiating a sample; a photodetector for detecting light emitted from a luminescent indicator in the sample; a sample receptacle; and a first light filter between the sample receptacle and the photodetector wherein the first light filter comprises a film comprising tartrazine or an analogue thereof.

The present inventors have found that Coomassie violet 8200, Victoria Blue B, acid fuchsin, CAS compound no. 63450-48-6, CAS compound no. 18462-64-1 and CAS compound no. 120724-84-7 may be provided in a film and used to filter light in a low pass filter.

Accordingly, in a second aspect the invention provides a sensor comprising a light source for irradiating a sample; a photodetector for detecting light emitted from a luminescent indicator in the sample; a sample receptacle; and a second light filter between the light source and the receptacle wherein the second light filter comprises a film comprising one or more of Coomassie violet R200, Victoria Blue B, acid fuchsin and analogues thereof, CAS compound no. 63450-48-6 available from Few Chemicals as 52278, CAS compound no. 18462-64-1 available from Few Chemicals as 50046 and CAS compound no. 120724-84-7 available from Few Chemicals as 50522.

In a third aspect the invention provides a method of detecting a luminescent indicator in a sample in or on a receptacle of a sensor according to the first or second aspect, the method comprising the step of illuminating the sample with the light source and detecting luminescence of the luminescent indicator incident on the photodetector.

In a fourth aspect the invention provides a filter film comprising a binder and tartrazine or an analogue thereof.

In a fifth aspect the invention provides a filter film comprising a binder and one or more of Coomassie violet R200, Victoria Blue B, acid fuchsin and analogues thereof, CAS compound no. 63450-48-6, CAS compound no. 18462-64-1 and CAS compound no. 120724-84-7.

In a sixth aspect the invention provides a kit comprising a sample receptacle and a first light filter comprising a film comprising tartrazine or an analogue thereof.

In a seventh aspect the invention provides a kit comprising a luminescent indicator having a peak wavelength in the range of 500-540 nm or a precursor thereof and a first light filter comprising a film comprising tartrazine or an analogue thereof.

In an eighth aspect the invention provides a kit comprising a sample receptacle and a second light filter between the light source and the receptacle wherein the second light filter comprises a film comprising one or more of Coomassie violet 8200, Victoria Blue B, acid fuchsin and analogues thereof, CAS compound no. 63450-48-6, CAS compound no. 18462-64-1 and CAS compound no. 120724-84-7.

In a ninth aspect the invention provides a kit comprising a luminescent indicator having a peak wavelength in the range of 500-540 nm or a precursor thereof and a second light filter comprising a film comprising one or more of Coomassie violet 8200, Victoria Blue B, acid fuchsin and analogues thereof, CAS compound no. 63450-48-6, CAS compound no. 18462-64-1 and CAS compound no. 120724-84-7.

### DESCRIPTION OF THE DRAWINGS

The invention will now be described in more detail with reference to the figures in which:

FIG. 1A illustrates a sensor according to an embodiment of the invention comprising a light source and a photodetector on opposing sides of a microfluidic device;

FIG. 1B illustrates a sensor according to an embodiment of the invention comprising a light source and a photodetector on the same side of a microfluidic device;

FIG. 2 is transmission spectra for filters containing tartrazine;

FIG. 3 is transmission spectra for a filters containing tartrazine overlaid with a fluorescence spectrum for Sodium Green;

FIG. 4 is transmission spectra for a filters containing tartrazine overlaid with a fluorescence spectrum for tartrazine;

FIG. 5 is transmission spectra for a filter containing fuchsin with and without Brilliant Blue FCF;

FIG. 6 is emission spectra for a filter containing fuchsin with and without Brilliant Blue FCF;

FIG. 7 is transmission spectra for a filter containing fuchsin and Brilliant Blue FCF and for a filter containing tartrazine; and

FIG. 8 is a graph of photodetector current vs. fluorescein concentration generated using a sensor according to an embodiment of the invention.

### DETAILED DESCRIPTION OF THE INVENTION

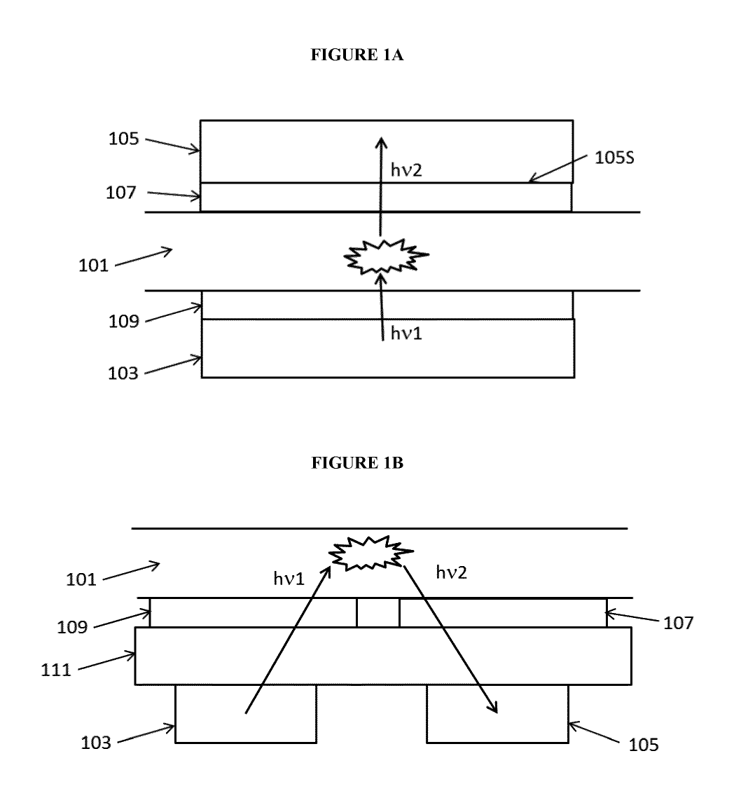

FIG. 1A, which is not drawn to any scale, illustrates a sensor suitable for use in a method as described herein comprising a light source 103, a photodetector 105 and a receptacle 101, a first filter 107 between the receptacle 101 and the photodetector 105 and a second filter 109 between the receptacle and the light source.

In use, a sample in receptacle 101 is illuminated with light from light source 103. The receptacle 101 is preferably a microfluidic device. The sample may be in a channel or chamber of the microfluidic device

The sample is illuminated with light from the light source having a peak wavelength hν1. Preferably, hν1 is less than 490 nm, optionally in the range 420-less than 490 nm.

The light source may have more than one peak wavelength. Optionally, the light source is a white light source. The light emitted from a white light source may have a CIE x coordinate equivalent to that emitted by a black body at a temperature in the range of 2500-9000K and a CIE y coordinate within 0.05 or 0.025 of the CIE y co-ordinate of said light emitted by a black body, optionally a CIE x coordinate equivalent to that emitted by a black body at a temperature in the range of 2700-6000K.

Light from the light source is absorbed and re-emitted by a luminescent indicator as light of longer wavelength hν2 which is detected by photodetector 105 having a surface 105S on which light emitted by the luminescent indicator is incident.

The first filter 107 comprises a film comprising a first filtering compound. The first filter allows little or no transmission of light having a wavelength hν1. Preferably, the first filter allows transmission of less than 10%, more preferably less than 5% or less than 1% of light of wavelength hν1 incident on the filter.

Preferably, the first filtering compound is tartrazine or an analogue thereof wherein at least one, optionally each, sodium cation of tartrazine is replaced with another cation, optionally another alkali metal cation or an ammonium cation.

The second filter comprises a filter film comprising a second filtering compound. The second filter allows little or no transmission of light having a wavelength hν2 that may be emitted from the light source.

Preferably, the second filtering compound is selected from one or more of Coomassie violet R200 and salts thereof; Victoria Blue B (chloride salt) and analogues thereof in which chloride is replaced with another anion, optionally another halide; acid fuchsin (sodium salt) and analogues thereof in which chloride is replaced with another anion; CAS compound no. 63450-48-6; CAS compound no. 18462-64-1; and CAS compound no. 120724-84-7.

The luminescent indicator preferably has a peak wavelength hν2 in the range of 500-540 nm.

The luminescent indicator may be a luminescent tag, for example a luminescent indicator bound to a protein, antibody or amino acid.

The luminescent indicator may be formed from a luminescent indicator precursor that undergoes a physical or chemical change when brought into contact with an analyte to be detected.

The luminescent precursor may be non-emissive or may be weakly emissive compared to the luminescent indicator upon irradiation by the light source.

The luminescent indicator is preferably a fluorescent indicator.

A fluorescein indicator as described herein may be a compound of formula (Ia) or (Ib) or a salt thereof:

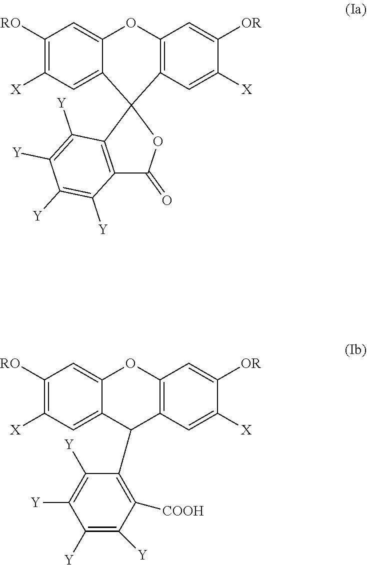

wherein X in each occurrence is independently H, F or Cl; Y is H or a substituent; and R is H or a substituent, optionally H or phenyl which may be unsubstituted or substituted with one or more substituents. Substituents of phenyl may be hydroxyl or amino groups.

Exemplary substituents X are chlorine, alkyl amino; phenylamino; and hydroxyphenyl. Exemplary fluoresceins include, without limitation, 2,7-dichlorofluorescein, 3′-(p-aminophenyl)fluorescein and 3′-(hydroyphenyl)fluorescein. Exemplary substituents Y are isothiocyanate; a carboxylic acid group or a salt or ester thereof, optionally a succinimate ester; amides; and —NR¹₃ wherein R¹ in each occurrence is H or a C₁₋₁₂ alkyl group. Optionally only one or two groups Y is a substituent, the remaining groups Y being H.

Exemplary fluorescent indicators suitable for use as fluorescent tags include, without limitation, fluorescein, fluorescein isothiocyanate, fluorescein NHS, Alexa Fluor 488, Dylight 488, Oregon green, DAF-FM and 6-FAM.

Exemplary fluorescent indicator precursors include, without limitation, Sodium Green, Corona Green, Fluo-F5, Magnesium Green and fluorescent proteins.

Preferably, the first filter allows transmission of less than 10%, more preferably less than 5% or less than 1% of light of wavelength hν1 incident on the filter.

Preferably, the first filter allows transmission of less than 10%, more preferably less than 5% or less than 1% of light having a wavelength less than 490 nm.

Preferably, the first filter allows transmission of at least 80%, more preferably at least 90% of light having a wavelength of 550 nm.

The first filter film preferably has a thickness of at least 1 micron, optionally up to about 25 microns.

Preferably, the second filter allows transmission of less than 10%, more preferably less than 5% or less than 1% of light having a wavelength of between 500 nm and 540 nm.

Preferably, the second filter allows transmission of at least 40% or at least 50% of light having a peak wavelength between 400-450 nm.

The second filter film preferably has a thickness in the range of about of at least 1 micron, optionally up to about 25 microns. nm.

The first filter film may comprise a first quencher for quenching fluorescence of tartrazine. Preferably the first quencher is 3,5-dinitrobenzoic acid.

The second filter film may comprise a second quencher for quenching fluorescence of the filtering compound therein. Preferably the second quencher is selected from the group consisting of Brilliant Blue FCF (sodium salt) and analogues thereof in which sodium is replaced with another metal cation or with an ammonium cation; IR-788 (available from Sigma Aldrich as 543292, cas. no. 115970-66-6), Nickel(II) phthalocyanine-tetrasulfonic acid tetrasodium salt (available from Sigma Aldrich as 274909, cas. no. 27835-99-0) and analogues thereof in which sodium is replaced with another metal cation or with an ammonium cation, and 3,3,3′,3′-Tetramethyl-1,1′-bis(4-sulfobutyl)benzoindodicarbocyanine sodium salt (available from TCI Europe Limited, CAS. no. 64285-36-5) and analogues thereof in which sodium is replaced with another metal cation or with an ammonium cation.

The first filter film and second filter film each preferably comprises a binder material in which the or each filter compound is dispersed. The binder material is preferably a water-soluble polymer, more preferably poly(vinylpyrollidone) (PVP).

Filter Film Formation

The first filter film and the second filter film may be formed on a substrate surface by any method including, without limitation, thermal evaporation and by solution deposition methods.

Preferably, each filter film is independently formed by casting onto a substrate surface a formulation comprising one or more solvents in which the or each filter material, and any other components of the film such as a binder or quencher, is dissolved or dispersed, and evaporating the or each solvent.

The one or more solvents preferably comprise water. Water may be the only solvent or may be mixed with one or more water-soluble solvents, optionally one or more alcohols, preferably a C₁₋₅ alcohol.

The transmission characteristics of a filter film may be affected the film thickness and/or concentration of filter material in the film. In particular, the transition between the film's passband and blocking band may be controlled within a range of up to about 20 nm, and the thickness of the film and/or concentration of the filter material may be selected to best match the spectrum of the luminescent indicator.

The thickness of the filter film may be controlled by selecting the volume of formulation deposited per unit surface area of the substrate surface that the formulation is deposited onto.

The filter film is supported on a surface of a transparent substrate, optionally glass or plastic. Exemplary transparent plastic substrates included, without limitation, PMMA, PET and PEN.

For the first filter, the substrate surface may be: a surface of the photodetector, optionally a surface of a substrate of the photodetector opposing the surface on which the photodetector is supported; a surface of the sample receptacle, optionally an external surface of a microfluidic device; or the first filter film may be supported on a substrate separate from a surface of the photodetector or the sample receptacle.

For the second filter, the substrate surface may be: a surface of the light source, optionally a surface of a substrate of the light source opposing the surface on which the light source is supported; a surface of the sample receptacle, optionally an external surface of a microfluidic device; or the second filter film may be supported on a substrate separate from a surface of the light source.

If the light source and photodetector are supported on a surface of a common substrate then the first and second filter films may be formed in different areas on an opposing surface of the common substrate.

Light Source

Any light source may be used including, without limitation, an inorganic LED or LED array; one or more organic light-emitting devices (OLEDs); a laser; or an arc lamp. The light source is preferably an OLED.

An OLED comprises an anode, a cathode and a light-emitting layer comprising an organic light-emitting material between the anode and the cathode. One or more further layers may be provided between the anode and the cathode, optionally one or more charge-transporting, charge injecting or charge-blocking layers. Upon application of a bias between the anode and cathode, light is emitted from the organic light-emitting material. OLEDs may be as described in Organic Light-Emitting Materials and Devices, Editors Zhigang Li and Hong Meng, CRC Press, 2007, the contents of which are incorporated herein by reference.

Photodetector

Any photodetector may be used including, without limitation, an organic photodetector (OPD), a charge-coupled device (CCD) or a photomultiplier, preferably an OPD or CCD.

An OPD comprises an anode, a cathode and an organic semiconducting region between the anode and cathode. The organic semiconducting region may comprise adjacent electron-donating and electron-accepting layers or may comprise a single layer comprising a mixture of an electron-accepting material and an electron-donating material. One or more further layers may be provided between the anode and the cathode. Conversion of light incident on the organic semiconducting region into electrical current may be detected in zero bias (photovoltaic) mode or reverse bias mode. OPDs may be as described in Ruth Shinar & Joseph Shinar “Organic Electronics in Sensors and Biotechnology” McGraw-Hill 2009, the contents of which are incorporated herein by reference.

Light Source—Photodetector Arrangements

In the embodiment of FIG. 1A, the light source 103 is provided on a first surface of the microfluidic device and the photodetector 105 is provided on an opposing, second surface.

It will be appreciated that the light source and photodetector may be provided in a wide range of other arrangements to sense emission of light from the luminescent indicator and may be used with, without limitation, light-absorbing layers, light-reflecting layers, lenses, optical fibres and combinations thereof.

FIG. 1B, which is not drawn to any scale, illustrates another sensor other arrangement in which the light source 103 and photodetector 105 are provided on the same surface of a common transparent substrate 111 such as a glass or transparent plastic substrate.

This arrangement is particularly advantageous in the case where the light source is an OLED and the photodetector is an OPD. The OPD and OLED of this embodiment may be formed using a common transparent anode layer on the substrate, optionally a common indium tin oxide layer.

The sensor may have a modular structure in which the receptacle is separable from the light source and/or photodetector. Optionally, a microfluidic device receptacle of the sensor comprises a single use glass or transparent plastic microfluidic chip which may be removed and replaced with another chip.

Optionally, the sensor is not modular, the entire sensor being a single-use sensor.

The sensor may be a portable device. The sensor may be a handheld device.

FIGS. 1A and 1B illustrate a sensor comprising a microfluidic device containing the sample, however it will be appreciated that the sample may be provided in or on another device, for example a lateral flow device.

FIGS. 1A and 1B illustrate a sensor having only one light source and only one photodetector. There may be more than one light source for each detector or more than one detector for each light source.

The sensor may be a multi-channel sensor, each channel comprising one or more light sources and one or more associated photodetectors.

Sample

The sample may be, without limitation, formed from any of the following substances to be analysed: human or animal bodily fluids, optionally a liquid selected from blood, urine, saliva, tears, faeces, gastric fluid, bile, sweat, cerebrospinal fluid and amniotic fluid; cell culture media or other biological samples; food; environmental water, e.g. river, sea or rain water; wine; soil extracts; and gases or other non-biological samples.

The sample may be formed by bringing the substance to be analysed into contact with a luminescent indicator precursor.

The luminescent indicator precursor as mixed with the substance to be analysed to form the sample may be in solid form or may be in solution. The sample is preferably a liquid sample. A liquid sample as described herein includes, without limitation a solution, a colloidal liquid or a suspension.

Applications

Applications of the sensor as described herein include, without limitation: pathogen detection, diagnostics, detection of disease related biomarkers, environmental monitoring, food safety control and military purposes. For example,
Glucose monitoring in diabetes patients
Detection of pesticides and river water contaminants
Remote sensing of airborne bacteria e.g. in counter-bioterrorist activities
Determining levels of toxic substances before and after bioremediation
Detection of organophosphate
Detection of electron acceptors, e.g. trinitrotoluene
Measurement of folic acid or vitamin B12
Determination of drug residues in food, such as antibiotics and growth promoters, particularly meat and honey
Drug discovery and evaluation of biological activity of compounds
Detection of toxic metabolites such as mycotoxins

### EXAMPLES

Measurements

Transmission spectra as described herein were measured by casting a 0.7 mm thick film of the compound or compounds of the filter onto a glass substrate and measuring transmission using a Agilent Cary 5000 Spectrophotometer with a blank glass substrate used as a baseline.

Fluorescence spectra as described herein were measured with an Ocean Optics USB2000+ spectrometer using a 5 mW, 450 nm laser diode as an excitation source. Fluorescence was collected via a fiber optic cable connected to the spectrometer. The fiber optic was positioned to collect reflected fluorescence emission and a longpass filter was used to prevent laser light entering the spectrometer.

### Filter Examples 1-3: Tartrazine Filters

Formulation were prepared by dissolving tartrazine, 3,5-dinitrobenzoic acid and polyvinylpyrrolidone (PVP) in amounts set out in Table 1 in a solvent of 50 vol % water and 50 vol % ethanol.

TABLE 1

| | Tartrazine | PVP | 3,5-dinitrobenzoic |
|---|---|---|---|
| Formulation | (wt %) | (wt %) | acid (wt %) |
| Formulation | 0.16 | 5 | 0.3 |
| Example 1 | | | |
| Formulation | 0.33 | 15 | 0.3 |
| Example 2 | | | |

Ethanol was added to the PVP and the mixture was agitated for several hours on rollers until the polymer dissolved.

Water was added to the tartrazine and 3,5-dinitrobenzoic acid and the mixture was agitated for several hours on rollers until the compounds dissolved.

The two solutions were mixed and the resultant solution was degassed by placing the solution in a sealed vial in an ultrasonic bath for 10 minutes.

A glass or plastic substrate was prepared by cleaning with isopropyl alcohol and then an adhesive silicone o-ring was placed around the edge of the substrate to contain the solution before placing on a hot plate.

A known volume of solution, selected according to a desired dry film thickness, was is pipetted onto the substrate.

The hotplate was turned on and set to 75° C. Upon reaching this temperature the substrate was left in place for 20 minutes to allow for solvent evaporation, producing a clear film.

Three films were formed as follows

Filter Example 1: Formulation Example 1, 0.16 ml/cm2

Filter Example 2: Formulation Example 1, 0.16 ml/cm2

Filter Example 3: Formulation Example 3, 0.33 ml/cm2

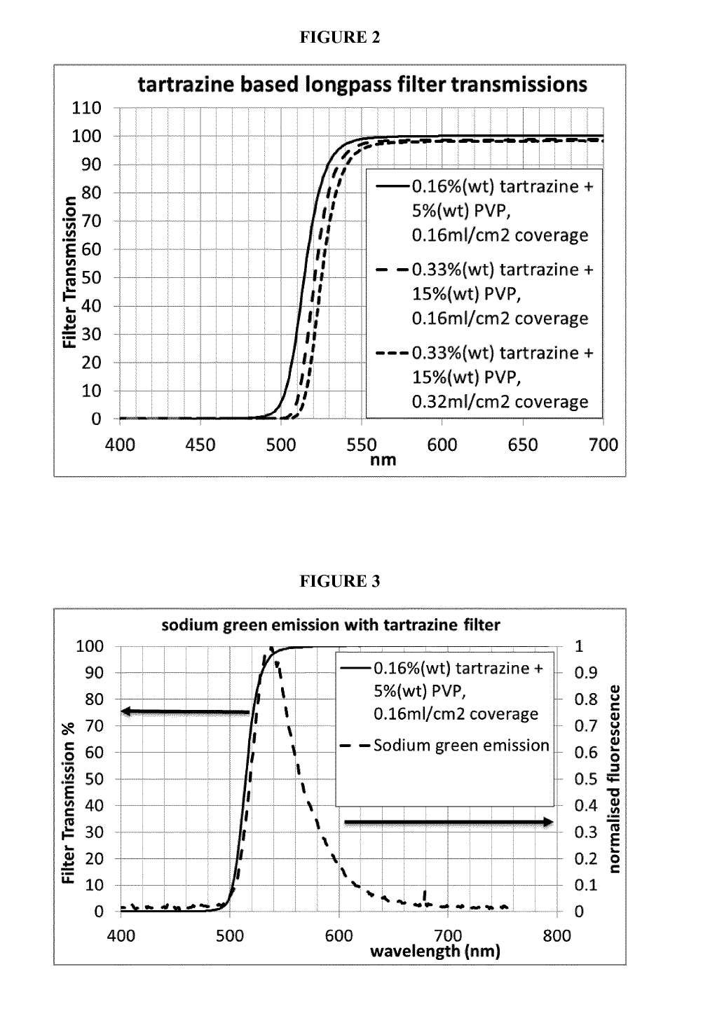

With reference to FIG. 2, Filter Examples 1-3 show high transmission at below about 500 nm and high absorption at above about 550 nm. The onset of the blocking band may be adjusted within a range of about 15-20 nm by selecting the concentration of the solution and/or the volume per unit area of the solution deposited onto the substrate.

FIG. 3 illustrates the transmission spectrum of Filter Example 1 overlaid with the fluorescence spectrum of Sodium Green.

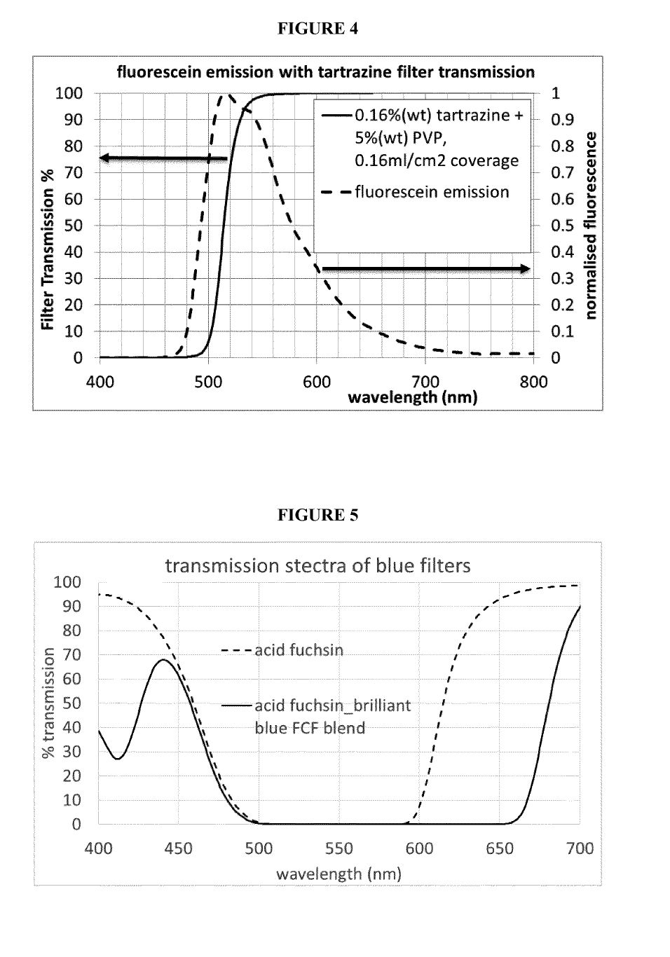

FIG. 4 illustrates the transmission spectrum of Filter Example 1 overlaid with the fluorescence spectrum of fluorescein sodium salt.

### Filter Example 4: Fuchsin and Brilliant Blue Filter

A filter film of Fuchsin 0.05 wt %, Brilliant blue FCF 0.05 wt % and PVP 2.5 wt % was formed according to the following method.

Ethanol was added to the PVP and the mixture was agitated for several hours on rollers until the polymer dissolved.

Water was added to the Fuchsin e and Brilliant blue and the mixture was agitated for several hours on rollers until the compounds dissolved.

The two solutions were mixed and the resultant solution was degassed by placing the solution in a sealed vial in an ultrasonic bath for 10 minutes.

A glass or plastic substrate was prepared by cleaning with isopropyl alcohol and then an adhesive silicone bund or o-ring was placed around the edge of the substrate to contain the solution before placing on a hot plate.

0.2 ml/cm² of the solution was pipetted onto the substrate.

The hotplate was turned on and set to 75° C. Upon reaching this temperature the substrate was left in place for 20 minutes to allow for solvent evaporation, producing a clear film.

### Filter Example 5: Fuchsin Filter

Filter Example 5 was prepared according to Filter Example 4 except that Brilliant Blue FCF was not included.

With reference to FIG. 5, fuchsin blocks transmission between about 500-600 nm, and this can be extended up to about 650 nm by inclusion of Brilliant Blue FCF with only a small reduction in transmission in the blue region of about 440-460 nm.

The light from a blue fluorescent OLED was filtered through Filter Example 4 and Filter Example 5.

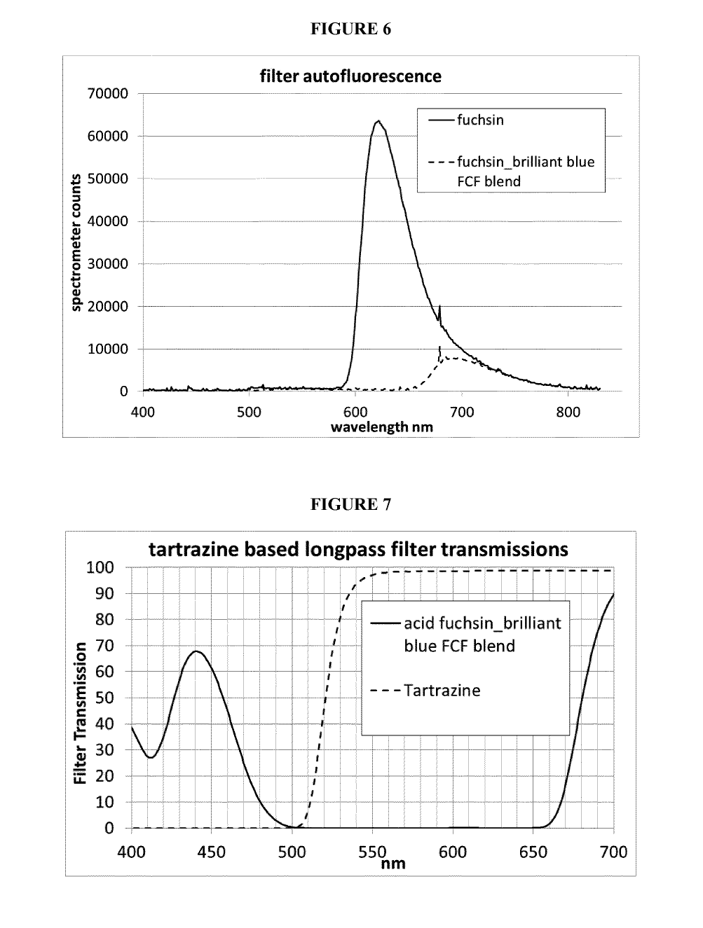

With reference to FIG. 6, the blue light irradiation of Filter Example 5 results in autofluorescence of fuchsin whereas the presence of Brilliant Blue in Filter Example 4 quenches almost all of this fluorescence and shifts the peak of the autofluorescence observed to a longer wavelength, making it easier to differentiate autofluorescence from fluorescence of a green emitting indicator such as fluorescein.

With reference to FIG. 7, the combination of transmission of Filter Example 4 and Filter Example 1 give little or no transmission at about 500 nm, meaning that little or no excitation light of this wavelength will pass through both filters.

### Sensor Example 1

A sensor having a structure as illustrated in FIG. 1A was prepared wherein the light source was a blue light emitting OLED having a 10 mm² OLED pixel; the photodetector is an OPD; and the receptacle is a 0.5 mm path length flowcell.

The OLED was supported on a glass substrate and comprised a transparent anode, a hole injection layer, a polymeric hole-transporting layer, a light-emitting layer comprising a fluorescent blue light-emitting polymer and a cathode. The peak emission wavelength of the OLED was 480 nm.

The OPD was supported on a glass substrate and comprised a transparent anode, a hole transporting layer, a layer of a mixture of a donor polymer illustrated below and a C70 fullerene acceptor material and a cathode.

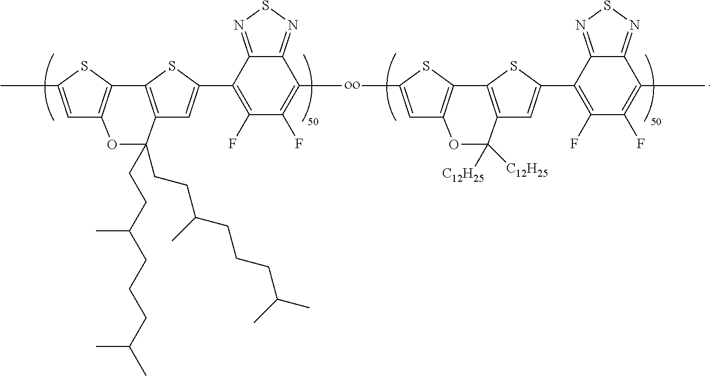

Fluorescein solutions of known concentrations between 1 μg/ml and 400 μg/ml were introduced into the flowcell. The OLED was driven for 100 ms at a current of 20 mA during which time the photocurrent from the unbiased OPD was measured for each solution using a Keithley 2400 digital source measure unit.

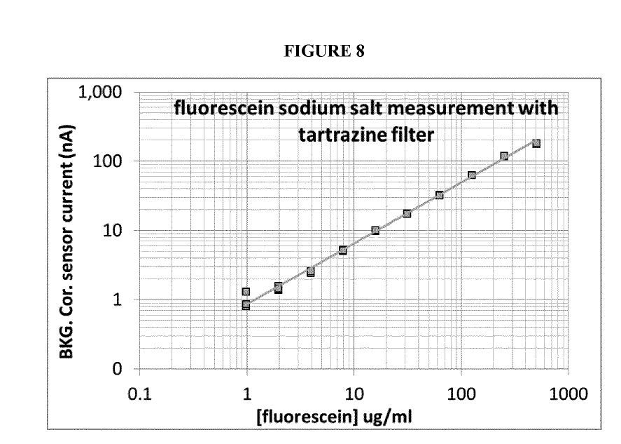

With reference to FIG. 8, the detector current increases linearly with fluorescein concentration across the measured range.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1. A sensor comprising a light source for irradiating a sample; a photodetector for detecting light emitted from a luminescent indicator in the sample; a sample receptacle; and a first light filter between the sample receptacle and the photodetector wherein the first light filter comprises a film comprising tartrazine or an analogue thereof.

2. A sensor according to claim 1 wherein the first light filter comprises a quencher.

3. A sensor according to claim 2 wherein the quencher is 3,5-dinitrobenzoic acid.

4. A sensor according to claim 1 wherein the sensor further comprises a second light filter between the light source and the photodetector wherein the second light filter allows transmission of less than 10% of light having a wavelength between 500 nm and 540 nm and at least 40% of light having a peak wavelength between 400-450 nm.

5. A sensor according to claim 1 wherein the luminescent indicator has a peak wavelength in the range of 500-540 nm.

6. A sensor according to claim 1 wherein the luminescent indicator is a fluorescein indicator.

7. A sensor comprising a light source for irradiating a sample; a photodetector for detecting light emitted from a luminescent indicator in the sample; a sample receptacle; and a second light filter between the light source and the receptacle wherein the second light filter comprises a film comprising one or more of Coomassie violet R200, Victoria Blue B, acid fuchsin and analogues thereof, CAS compound no. 63450-48-6, CAS compound no. 18462-64-1 and CAS compound no. 120724-84-7.

8. A sensor according to claim 1 wherein the light emitted from the light source has a peak wavelength of less than 490 nm.

9. A sensor according to claim 1 wherein the sample receptacle is a microfluidic device.

10. A sensor according to claim 7 wherein the second light filter comprises a quencher.

11. A sensor according to claim 10 wherein the quencher is selected from the group consisting of Brilliant Blue FCF, Nickel(II) phthalocyanine-tetrasulfonic acid tetrasodium salt, and 3,3,3′,3′-Tetramethyl-1,1′-bis(4-sulfobutyl)benzoindodicarbocyanine sodium salt.

12. A sensor according to claim 7 wherein the sensor further comprises a first light filter between the photodetector and the sample receptacle wherein the first light filter allows transmission of less than 10% having a wavelength less than 490 nm.

13. A method of detecting a luminescent indicator in a sample in or on a receptacle of a sensor according to claim 1, the method comprising the step of illuminating the sample with the light source and detecting luminescence of the luminescent indicator incident on the photodetector.

14. A method according to claim 13 wherein the luminescent indicator emits light having a peak wavelength in the range 500-540 nm.

15. A method according to claim 13 wherein the luminescent indicator is formed from fluorescein, sodium green or an analogue thereof.

16. A filter film comprising a binder and a compound selected from the group consisting of: tartrazine or an analogue thereof, Coomassie violet R200, Victoria Blue B, acid fuchsin and analogues thereof, CAS compound no. 63450-48-6, CAS compound no. 18462-64-1 and CAS compound no. 120724-84-7.

17. A kit comprising a sample receptacle and a light filter comprising a filter film according to claim 16.

18. A kit according to claim 17, the kit further comprising a light source for irradiating a sample in or on the sample receptacle and a photodetector for detecting light emitted from a luminescent indicator in the sample.

19. A kit according to claim 17, the kit further comprising a luminescent indicator having a peak wavelength in the range of 500-540 nm or a precursor thereof.

20. (canceled)

21. (canceled)

22. (canceled)

23. (canceled)
